(19) United States
(12) Patent Application Publication
(10) Pub. No.: US 2020/0363323 A1
(43) Pub. Date: Nov. 19, 2020

(54) SPECTROMETER

(71) Applicant: CSEM CENTRE SUISSE D'ELECTRONIQUE ET DE MICROTECHNIQUE SA - RECHERCHE ET DÉVELOPPEMENT, Neuchâtel (CH)

(72) Inventors: Giorgio QUARANTA, Saint-Louis (FR); Guillaume BASSET, Huningue (FR); Martin STALDER, Oberwil (CH); Benjamin GALLINET, Muttenz (CH); Rolando FERRINI, Bern (CH)

(21) Appl. No.: 16/766,134

(22) PCT Filed: Nov. 20, 2018
(86) PCT No.: PCT/EP2018/081970

§ 371 Date: May 21, 2020

(30) Foreign Application Priority Data
Nov. 21, 2017 (EP) PCT/EP2017/079966

(51) Int. Cl. G01N 21/31

(52) U.S. Cl. CPC G01N 21/31; G01N 2201/062; G01N 2201/0638; G01N 2201/0635; G01N 2201/0633

(57) ABSTRACT

An ultra-thin spectrometer is disclosed for measuring spectra of a sample, including an optical layer including micro-optical elements having each an input acceptance cone of is less than 30°. At least one of the micro-optical elements is configured to provide a deflected light beam that is directed onto at least one of the photodetectors; The spectrometer includes least one continuous-shaped narrow spectral band filter element arranged between the array of micro-optical elements and the plurality of photodetectors, and defines a plurality of different filter portions that have different peak transmission wavelengths for each of the deflected light beams. The spectral resolution of the spectrometer, in its whole spectral width, is less than 50 nm. Also disclosed is a method to determine the spectrum of an incident light beam on the spectrometer.

### TECHNICAL FIELD

The present invention relates to the field of spectrometer devices. More particularly, the present invention relates to thin or compact spectrometers including spectrometer devices for the ultraviolet, visible and infrared ranges of the electromagnetic spectrum. The invention relates also to methods of use of the thin or compact spectrometer.

### BACKGROUND

Optical spectrometers, often simply called “spectrometers”, show the intensity of light as a function of wavelength or of frequency. Because the intensity of light at different wavelengths caries information about the light source, such as a signature of its chemical composition, spectrometers have found wide applications in astronomy, physics, chemistry, biology, medial applications, energy, environmental monitoring and other areas.

Most spectrometers used today are based on designs dated from the nineteenth century, wherein the deflection, also called optical dispersion, of incident light in different directions is produced either by refraction in a prism or by diffraction in a diffraction grating, and in some cases by the combination of refractive and diffractive elements. By a spectrometer the intensity at different wavelengths may be measured.

The light incoupled in a spectrometer comes from a light source that can consist of a continuous spectrum, an emission spectrum (bright lines), or an absorption spectrum (dark lines). Because each element leaves its spectral signature in the pattern of lines observed, a spectral analysis can reveal the composition of the object being analyzed.

Optical spectrometers are important analytical instruments that are commonly used in a wide variety of applications and their overall dimension depends on these applications. Their volumes and diameters can have huge ranges and for some applications the spectrometer needs to be filled with a gas or may be require a high vacuum in which the dispersed light transits from an entry to a fixed or movable detector or detector array. Some spectrometers, for example optical emission spectrometers for industrial applications, based on the use of diffraction gratings and a Rowland circle configuration can have meter size diameters and weigh more than 500 kg. In other spectrometers prisms may be used as the dispersing element as described in the document EP 1691180 A2. In any case wherein a prism or a grating or both of them are used as the dispersive element, the spectrometer requires a long optical path, which implies that the involved dimensions are large and which cannot be used for applications wherein the size is an essential aspects, such as in the case of smartphones or other portable devices or instruments.

Recently there is a trend to develop versatile and reliable low and medium resolution spectrometers that have a very small size, typically having volumes of 250 cm³ or less, for typical applications such as found in the medical field or where available space or transportation issues are important. The reduction of the spectrometer's complexity and the addition of new functionalities are also important criteria.

For a number of applications there is a need for thin spectrometers that have a high resolution and that have a reduced thickness, for example below 3 mm so that they can be integrated in, for example, compact mobile electronic devices or in wearable electronic devices.

Some approaches have tried to solve the above mentioned limitations of compact prior art spectrometers. For example FIG. 1 illustrates a compact spectrometer based on a configuration comprising an entry slit (S) through which an incident beam (i) passes, a concave diffraction grating (G) and a CMOS (C) sensor (www.hamamatsu.com/eu/en/4016-html). The size of this spectrometer is about 20 mm×12.5 mm×10 mm, its spectral response range between 340 nm and 780 nm and its spectral resolution is lower than 15 nm. The concept of this spectrometer still requires a propagation length of the dispersed light beams (d1-d3) of about 10-15 mm and this cannot be reduced without further reducing the spectral resolution and/or the sensitivity of the spectrometer.

In another realization illustrated in FIG. 2 (www.chromation.com) the spectrometer comprises a waveguide and a diffraction outcoupling grating. The spectrometer provides an array of outcoupled light beams (λ1-λ4) away from the direction of the incoupled light direction This design suffers from the fact that the requirement of a waveguide makes the system complex because of the interfaces between the waveguide and the dispersion element and the system is further limited by the fact that the light must be incoupled from the side of the spectrometer. Various wavelengths are outcoupled from the waveguide at various angles thanks to the outcoupling grating; however they must propagate at different distances so that they can be separated spatially over a predetermined distance. Because of the needed incoupling optics to the waveguide, the waveguide dimension and the needed distance to the outcoupling grating where a measurement may be performed, the spectrometer remains too bulky for a lot of application wherein size is important.

An example of a compact spectrometer is disclosed in US2017059405. Such a spectrometer requires either a housing comprising a slit or two fiber bundles between the light source and a dispersive element. Such an arrangement imposes a minimal distance between the light source and an array of filters and the array of photodiodes, again limiting possible reduction of the overall size of the spectrometer.

Another variant of a compact portable spectrometer, which concept is illustrated in FIG. 3, is described in the document WO2016/125165. The spectrometer comprises a light diffusor D to homogenize the incident light beam into the spectrometer. The spectrometer comprises a small number of separate interference filters F1-F3 and different light beams emitted at a different angle from the diffusor are incident on the array of different interference filters. Because of the angular dependence of the interference filters, light beams having different spectra are directed to an array I of photodetectors by separate lenses L. The spectral band that is covered by each of the filter-lens subsystem is a function of the numerical aperture (NA) of each lens. In order to cover a wide spectral band several lens-filter subsystems are required as illustrated in FIG. 3. In order to improve the spatial homogeneity of the light that is provided to the spectrometer at least one additional diffuser may be used. The spectrometer described in WO 2016/125165 presents several miniaturization limitations so that it would not be possible to integrate it into small volumes such as the one that are available in portable consumer electronic devices such as smartphones. First, the realization of a single filter F1-F3 requires a number of processing steps, so that in order to limit the manufacturing costs only a small number, typically 3 to 5, of filters having a different spectral response may be provided into the spectrometer. Also, in order to minimize the thickness of the device, the lenses L must have a small focal length, which implies a high NA and imposes the use of single lenses for each lens-filter subsystem. Furthermore, realizing microlenses having a high numerical aperture is complex and costly. Scaling down the lenses would drastically increase the manufacturing costs and such lenses would have high spherical aberrations, resulting in a non-perfect imaging of the angular distribution of the angular distribution of the light beams provided by the diffuser and directed to the different photodetector elements, which would require complex signal processing in order to retrieve spectral information of the targeted object. A small entrance pupil may be used in order to improve the angular image quality, but this would imply large losses and lead to a high noise level.

In summary, it is difficult to reduce further the dimensions of existing compact spectrometers without losing spectral resolution and/or sensitivity and/or signal to noise ratio as a minimal volume is necessary to spread the incoming optical beam or to separate spatially colors after diffraction. Present compact spectrometers are angle sensitive and cannot handle incident light coming at any angle on the spectrometer or have to rely on a bulky and/or complex light diffuser. Also, color filtering elements are usually highly angular sensitive elements and the angular filtering is commonly done by a pinhole or slit aperture located at a distance from the color filtering elements, resulting in a bulky design, or allow large incidence inside the spectrometer which limits the possible resolution, or allow only very reduced intensities to enter the spectrometer using a very small pinhole or slit.

In other developments, tri-chromatic Red Green Blue (RGB) cameras are relying commonly on chemical dies to filter, by absorption, the complementary portion of the visible spectrum to the three primary colors, RGB. In such a configuration, different pixels of an imager enable to image a scene and to be selective to a few different spectral bands, usually three. Such configurations is common in RGB image sensors integrating a Bayer color-filter or have been used for very basic color analysis of ambient light such as disclosed in the document U.S. Pat. No. 8,008,613. Such color filtering can be made compact but is extremely complex and costly to upscale for more complex spectrum measurements including many spectral channels. Color filter dies that allow filtering out large spectral ranges and transmitting a single spectral portion are not common and not available for a great number of spectral portions of the UV, visible and IR ranges. Additionally, the accurate printing of many different color filter dies with registration can be complex and expensive to realize.

Replacing dye-based color filters by other color filters not based on absorbing chemical dies cannot be made directly as these are usually angularly sensitive. They therefore require additional optical systems to select a set of angles impeding on them. And such optical configurations, for example based on a slit or aperture located at a distance from the color filter not based on absorbing chemical dies cannot be miniaturized without losing dramatically the optical quality of the spectrometers.

Other developments related to multi-spectral image sensors have been considered. They usually rely on different optical filters for spectrally filtering the incident light before impeding on the imager sensors pixels. Many different spectral optical filtering techniques have been developed. However, all the known multi-spectral image sensors rely on bulky and unique aperture optics, making the overall spectrometer or imaging spectrometers bulky, despite the high compactness of the spectral sensor itself.

### SUMMARY OF THE INVENTION

It is the aim of this invention to provide an improved spectrometer apparatus and method. The spectrometer of the invention has a smaller thickness than spectrometers of prior art, while having a high sensitivity, a high resolution and a great design flexibility. The spectrometer of the invention may also be produced by scaling down the dimensions, lowering considerably the manufacturing costs.

The spectrometer can be realized in many forms, has a predetermined field of view and provides wavelength multiplexing in which a plurality of wavelengths of light provided by a sample, in said field of view, may be analyzed. Spectral data of a sample can be used to determine one or more attributes of a sample. A light source may be integrated in the spectrometer so that a portion of the optical beam reflected from the sample may be analyzed.

More precisely the invention is achieved by providing a spectrometer comprising an optical layer comprising an array of micro-optical components that are each angular selective and that provide each a deflected light beam. The spectrometer comprises also spectrally selective optical filter and an array of photodetectors allowing measuring the spectral distribution of an incoming light beam by combining the electrical signal of the photodetectors.

By using said optical layer, it is possible to obtain a very small thickness independently from the number of channels of the spectrometer, from its spectral resolution and from its angular acceptance. The amount of light entering the spectrometer after said optical layer is equivalent to the light entering the total aperture of spectrometers of prior art. The spectrometer of the invention allows to achieve a much higher sensitivity over its spectral analysis range, compared to spectrometers of prior art with considerably reduced thickness.

To the contrary of prior art spectrometers, the size of the spectrometer of the invention allows to be integrated in small systems such as mobile phones, tablets and small-size wearable electronic equipment. The spectrometer of the invention is preferably designed to analyze light incident in free-space, preferably in air, towards its light incident surface.

More precisely the spectrometer comprises an optical layer comprising an array of micro-optical elements defining a virtual light collecting surface, and a plurality of photodetectors and at least one optical filter, said array and said plurality of photodetectors defining a total field of view Ω to measure the spectra of said sample

Each of said micro-optical elements defines a local entry surface and a central axis perpendicular to said local entry surface and an input acceptance cone having a solid angle of which the total aperture, defined in any plane comprising said central axis is less than 30°, said cone having a predetermined spatial orientation relative to said central axis. At least one of said micro-optical elements is configured so that an incident light beam incident on said local entry surface provides a deflected light beam having a central light ray that has a predetermined deflection angle different than zero, directed onto at least one of said photodetectors. At least one continuous-shaped narrow spectral band filter element is arranged between said array of micro-optical element and said plurality of photodetectors. Said filter element defines a plurality of different filter portions that have different peak transmission wavelengths for each of said deflected light beams.

In an embodiment said optical layer comprises at least one angular filter layer and at least one deflecting layer said angular filter layer comprising an array of angle limiting optical elements that are each configured to limit the acceptance angle of transmitted light through said optical elements, said deflecting layer comprising deflecting optical elements configured to deflect and direct each of said deflected light beams onto at least one of said photodetectors.

In an embodiment said at least one deflecting layer is arranged between said at least one angular filter layer and said plurality of detectors.

In an embodiment said at least angular filter layer is arranged between said at least one deflecting layer and said plurality of detectors.

In an embodiment more than 50%, preferably more than 75%, preferably even more than 90%, of said deflected light beams have deflection angles that are superior to 1° or 3°.

In an embodiment the thickness of said spectrometer, defined in the direction of a normal N to said light collecting surface is less than 1 mm and its largest width, defined in the plane of said light collecting surface is less than 3 mm.

In an embodiment said optical layer is configured so that at least two of said photodetectors receive different and partially overlapping spectral portions of light provided by an incident light beam.

In an embodiment the geometrical distribution said photodetectors in the plane of said plurality of photodetectors is non uniform.

In an embodiment said angular filter layer comprises an opaque layer comprising at least one array of pinholes and/or an array of microslits.

In an embodiment said angular filter layer comprises at least one array of microlenses.

In an embodiment angular filter layer comprises at least two arrays of microlenses comprising different microlenses. In an advantageous variant said at least two arrays comprise microlenses having opposite oriented microlens curvatures. In an embodiment at least two arrays of microlenses are decentered in respect to each other. In variants said each of said pinhole and/or microslit is situated centered on said central axis.

In an embodiment said at least one deflecting layer comprises an array of prisms.

In an embodiment said at least one deflecting layer comprises an opaque layer comprising at least one array of pinholes and/or an array of microslits.

In an embodiment at least one of said deflecting optical elements comprises a diffraction grating. In variants at least one of said diffraction gratings (is not parallel with the plane of said filter element.

In an embodiment said at least one deflecting layer comprises at least one liquid crystal device.

In an embodiment at least one of said angle limiting optical elements and/or said deflecting optical elements comprises a reflective surface.

In an embodiment each of said angular limiting optical elements and/or said deflecting optical elements is configured according to a catadioptric configuration.

In an embodiment the opening and/or the position of said array of pinholes or said array of microslits may be changed by electronic means.

In an embodiment wherein said filter element is made of a substrate comprising a single interference layer stack.

In an embodiment said filter element is made of at least two substrates comprising each a different interference layer.

In embodiment said interference layer is substituted by an array of resonant gratings. In variants said resonant gratings are chirped resonant gratings. In other variants said optical filter element comprises a plasmonic filter based on local resonances. In embodiments said plasmonic filter is based on surface plasmon-polaritons.

In an embodiment said angular filter layer and/or said at least one deflecting layer comprises means so that light cannot be transmitted between different angle limiting optical elements and/or between different deflecting optical elements.

In an embodiment at least one light source is arranged in the layer comprising said photodetectors and configured to send at least one emitted lightbeam is passing, in operation, through said optical layer to illuminate a sample to be analyzed.

In an embodiment said spectrometer comprises signal processing means to process data provided by said array of photodetectors, said processing means being configured to allow to reconstruct at least a portion of the spectrum of the light provided by an incident light beam on said light collecting surface.

In an embodiment said optical layer comprises an array of linear shaped optical layers arranged in two dimensions and so that in a first direction the optical layer focuses the incident light beams on said detector array without spectral dispersion and so that incident light on said focal plane spectrometer is spectrally dispersed in a second direction different than said first direction.

The invention is also achieved by a spectrometer system comprising at least one of the described spectrometers.

The invention is also achieved by method to provide a spectrum of an emitted light beam provided by an illuminated sample comprising the steps (a-e) of:
a. providing a spectrometer or a spectrometer system as described;
b. directing said spectrometer to that said emitted light beam is incident on said virtual light collecting surface 1a;
c. converting the incident light beam into transmitted light beams;
d. deflecting said transmitted light beams on said detectors to provided electrical charges;
e. converting said electrical charges into electrical output signals, each electrical output signal being proportional to the light intensity of said incident light beams on said detector elements.

In embodiments the method comprises an additional step f of:
f. converting said electrical output signals into a signal representing the spectrum of said incident light beam, said signal representing the spectrum of said incident light beam having at least 6 spectrally independent components.

In embodiments the method comprises the additional step g of:
g. performing a correlation between the electrical output signals so as to generate a signal representing the spectrum of said incident light beam.

In embodiments the method comprises comprising a calibration comprising steps h-j of:
h. illuminating, before step a, said spectrometer with a light beam having a known spectral composition;
i. generating a reference signal
j. correcting, by using said reference signal, said electrical output signal provided by said step d.
   In embodiments the method comprises said illumination is realized by light sources integrated between detectors of the detector array.

In embodiments the method comprises said illumination is realized by pulsed light sources and in which the detector array if synchronized with the light emitting frequency of said light sources, so as to provide a lock-in detection scheme.

### BRIEF DESCRIPTION OF THE DRAWINGS

Further details of the invention will appear more clearly upon reading the following description in reference to the appended figures:

FIGS. 1-3 show three different spectrometers of prior art;

FIG. 4 illustrates a cross-section of a thin spectrometer of the invention;

FIG. 5 illustrates a cross-section of a variant of a spectrometer of the invention comprising a photodetector array having, in its plane, a non-uniform distribution of its photodetectors;

FIG. 6 illustrates a cross-section of a spectrometer of the invention comprising an optical layer comprising a microlens array of which microlenses have an inclined back surface relative to the plane of the microlens array;

FIG. 7 illustrates an optical layer comprising micro optical elements that each are made of a stack of layers having each a different refractive index;

FIG. 8 illustrates an exemplary 3D view of a spectrometer of the invention;

FIG. 9 illustrates a cross-section of a spectrometer of the invention comprising an angular filter layer comprising a first array of microlenses having each a pinhole arranged on its back surface and a deflecting layer comprising an array of decentered microlenses relative to the microlenses of said first array of microlenses;

FIG. 10 illustrates a top view of a spectral plane spectrometer comprising a plurality of linear-shaped optical layers according to the invention;

FIG. 11 illustrates a cross-section of a spectrometer of the invention comprising an angle limiting layer comprising an array of microlenses and an array of associated pinholes or slits, and a deflecting layer comprising deflecting optical elements that are made of microprisms on an array of associated pinholes or slits is arranged;

FIG. 12 illustrates a portion of a cross section of the spectrometer of the invention illustrating a single angle limiting optical element and a deflecting optical element comprising a double pinhole or slit and a deflecting microelement having a V-shaped surface to the side of the filter element of the spectrometer;

FIG. 13 illustrates a cross-section of a spectrometer of the invention comprising an optical layer comprising an angle limiting element comprising two arrays of opposite shaped and different microlenses comprising an array of pinholes or slits in between said two arrays of microlenses;

FIG. 14 illustrate a cross-section of a spectrometer of the invention comprising a deflection layer comprising a plurality of light deflecting diffractive elements that are inclined relative to the plane of the filter element;

FIG. 15 illustrates a cross-section of a spectrometer of the invention comprising two different filter elements, each configured for a different spectral range;

FIGS. 16-19 illustrates different spectra obtained by resonant waveguide gratings, the spectra are shown in function of the viewing angle of the optical elements of the optical layer;

FIG. 20 illustrates the cross-section of a plasmonic grating covered with metallic silver and the transmission spectrum of TM polarized light of a plasmonic filter based on various periodicities of such a grating;

FIG. 21 shows the transmission spectrum of TM polarized light through a specific resonant waveguide grating filter at varying incidence angles for a period of 256 nm.

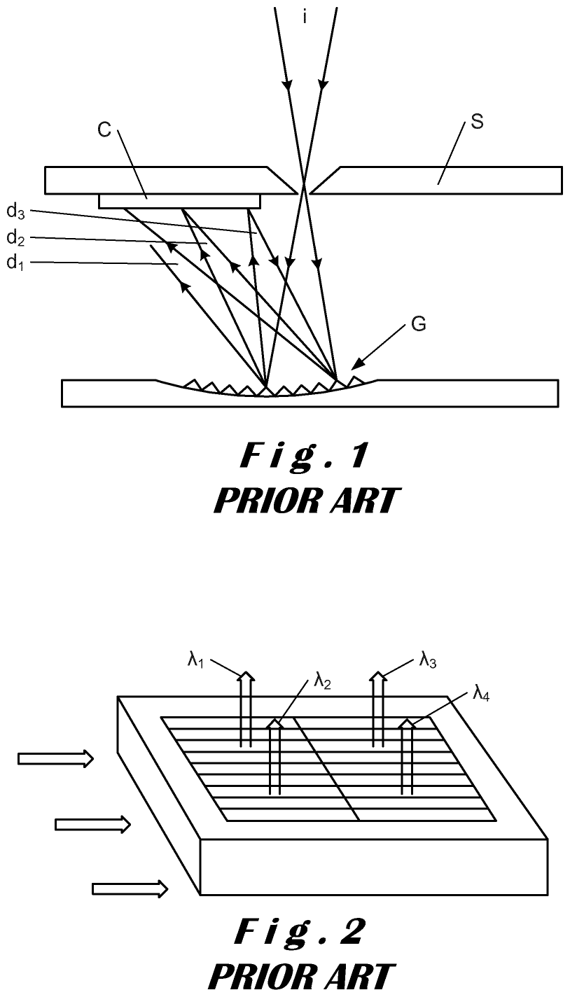

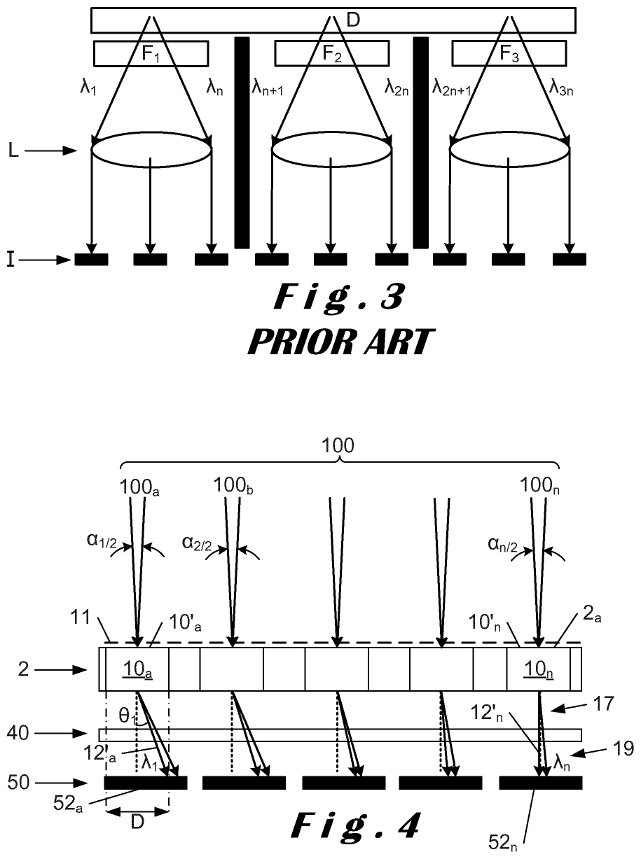

### EMBODIMENTS OF THE INVENTION

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes. The dimensions and the relative dimensions do not correspond to actual reductions to the practice of the invention.

It is to be noticed that the term “comprising” in the description and the claims should not be interpreted as being restricted to the means listed thereafter, i.e. it does not exclude other elements.

Reference throughout the specification to “an embodiment” means that a particular feature, structure or characteristic described in relation with the embodiment is included in at least one embodiment of the invention. Thus appearances of the wording “in an embodiment» or, “in a variant”, in various places throughout the description, are not necessarily all referring to the same embodiment, but several. Furthermore, the particular features, structures or characteristics may be combined in any suitable manner, as would be apparent to a skilled person from this disclosure, in one or more embodiments. Similarly, various features of the invention are sometimes grouped together in a single embodiment, figure or description, for the purpose of making the disclosure easier to read and improving the understanding of one or more of the various inventive aspects. Furthermore, while some embodiments described hereafter include some but not other features included in other embodiments, combinations of features of different embodiments are meant to be within the scope of the invention. For example, any of the claimed embodiments can be used in any combination. It is also understood that the invention may be practiced without some of the numerous specific details set forth. In other instances, not all structures are shown in detail in order not to obscure an understanding of the description and/or the figures. The term “light” includes here visible light as well as UV and IR radiation, covering wavelengths between 100 nm (deep UV) and 20 μm (infrared), and typical wavelength are between 250 nm and 1500 nm, and more typically between 350 nm and 1100 nm.

Also, the dimensions of optical beams as described herein can be defined and determined in one or more ways. The size of a light beam or a cross section of a light beam comprises a full width at half maximum intensity of that light beam, for example. The light beams described in the present application may comprise blurred edges. The wording “cone” or “cone of light” is to be understood large in the sense that it is not necessarily exactly the shape of a cone but may be a shape such as a tapered cone of which lateral cross section may vary along the axis of that cone-like shape. The term “field of view”, means that only light into a spatial cone may transit through the optical element that defines the field of view. The wording “total field of view” means the total angular extent of directions in which light may be provided to the spectrometer.

The wording “transmitted” and “transmitted light or light beams” means that incident light beams on an optical element are converted into a transmitted light beams 1 to a large extent, for example lowered in intensity by reflections at interfaces and that according to basic optics the étendue stays the same. In other words, only light within said spatial solid angle θ is transmitted and may reach said photodetectors. The angular-ranges on both axis normal to a light collecting surface may be different. Transmitted light beams in the spectrometer are spectrally filtered before reaching at least a portion of the light collecting surfaces of the detector array layer 50.

Also, the wording “continuous shaped filter” means that the element is made of a single part and not an assembly of discrete parts. For example, a continuous shaped element may be a sheet that may be a flexible or rigid sheet or may be a single plate.

Further, the wording “virtual light collecting surface” is defined broadly and defines a plane that may be defined as the input aperture of the spectrometer and is typically defined between the optical layer 2 as described further and the sample to be measured. The “virtual light collecting surface”, defined also as light collecting surface, does not necessarily have to coincide with any of the physical surfaces of the spectrometer and may be a surface defined at the entry of an entry baffle of the spectrometer.

The invention includes the following embodiments.

The general concept of the compact spectrometer 1 of the invention is illustrated in FIG. 4 in accordance with embodiments and configurations. The spectrometer 1 can be used for different purposes, mainly to analyze samples. In particular the spectrometer 1 can be used to identify properties of the surface of objects and may be integrated in portable devices such as cellphones or the like. As further described the spectrometer may be integrated in a spectrometer system comprising additional optical elements such as lenses and/or mirror. The spectrometer comprises a detector array and may comprise, as further described, signal processing electronic circuits. Such circuits may be integrated in a spectrometer 1 of the invention or into a spectrometer system that may comprise for example a microprocessor and electric circuits to preprocess or process signals provided by the spectrometer.

FIG. 4 shows that the spectrometer 1 of the invention comprises:
an optical layer 2, defining an entry surface 2a, comprising an array 10 of micro-optical elements 10a-10n defining each light collecting surfaces 10′a-10′n which may be said virtual light collecting surface 11,
a plurality 50 of photodetectors 52a-52n,
at least one optical filter 40,
a plurality 50 of photodetectors 52a-52n.

FIG. 8 shows a 3D view of a spectrometer 1 of the invention. For reasons of clarity FIG. 8 does not show additional layers that may be required in some embodiments, such as an additional opaque layer comprising pinholes. More precisely, each of said micro-optical elements 10a-10n of said optical layer 2 defines a local entry surface 10′a-10′n as well as a central axis 12″a-12″n oriented perpendicular to said local entry surface 10′a-10′n. In preferred embodiments, as further described, said central axes 12″a-12″n are the central axis of angular limiting elements 20a-20n. Also, each of said micro-optical elements 10a-10n defines an input acceptance cone having a solid angle Ω1-Ωn of which the total aperture α1-αn, defined in any plane comprising said central axis 12″a-12″n, is less than 30°, preferably less than 20°. FIG. 8 shows a 3D view illustrating, for clarity, the field of view of a single micro-optical element 10a-10n Each of said input acceptance cones has a predetermined spatial orientation relative to said central axis 12″a-12″n and/or relative to the normal N to the plane of said light collecting surface 11. The light collecting surface 11 may be defined by the entry surfaces of said optical layer 2 but may also be one of the surfaces of a protection layer arranged to said optical layer 2.

At least one of said micro-optical elements 10a-10n is configured so that an incident light beam incident 100a-100n on said local entry surface 10′a-10′n provides, a deflected light beam 12a-12n, as illustrated in schematically in FIGS. 4 and 5. Each of said deflected light beams 12a-12n has a central light ray 12″a-12″ that has a predetermined deflection angle θ1-θn and is directed onto at least one of said photodetectors 52, preferably to a predetermined portion of such photodetector. At least one of said deflection angles θ1-θn may be zero, meaning that the light beam 12a-12n that is not deflected, is substantially parallel to the local central axis 12″a-12″n.

In embodiments, preferably at least 50%, more preferably at least 75% of said micro-optical elements 10a-10n are configured so that respectively at least 50% or 75% of said deflected light beams 12a-12n have a central light ray 12″a-12″ have a predetermined deflection angle θ1-θn higher than 1°, preferably higher than 3° relative to the local normal of said filter element 40. It is understood also that de percentage of deflected light beams 12a-12n may be different in function of the minimum defection angle. For example, more than 50% of the deflected light beams 12a-12n may have a deflection angle higher than 1° and more than 30% may have a deflection angle higher than 3°. Also, the range of deflection angles may be limited, for example, 90% of the deflection angles may be within 5° and 45°. Said central light ray 12″a-12″ is defined broadly as the chief ray of the deflected light bundle 12a-12n but may also be the ray that presents the ray of highest intensity of the transmitted light bundle 12a-12n. It is understood that the deflected light bundles may have very different shapes and intensities and/or intensity profiles defined in a section parallel to said optical filter element 40 or in any other plane.

The percentage of deflected beams 12a-12n depends on the number of spectral channels and is a design parameter of the spectrometer. For example, if 5 spectral channels are desired, the spectrometer will be configured so that about 80% of the beams 12a-12n is deflected in operation. If 10 spectral channels are necessary, about 90% of the beams 12a-12n is deflected in operation. Preferably at least 95% of the beams 12a-12n is deflected in operation when there are more than 20 channels. More precisely, it is an advantage that at least 86% of the beams 12a-12n is deflected light beams for a case where 7 spectral channels are present. In other variants the layers 2, 20, 30 of the spectrometer may be arranged so as to provide deflected beams 12a-12n that have very high deflection angles such as angles higher than 45°. It is also understood that the filter element 40 may comprise structures so as to improve the transmission characteristics of the incident light beams 12a-12n. For example, the filter element may have a patterned diffraction structure on at least one of its lateral surfaces.

It is understood that non deflected beams 12a-12n may serve for referencing purpose, and/or may constitute a light beam useful in the completion of the spectrum. It is also understood that in some embodiments at least one of the deflected light beams 12a-12n may comprise two separate beams progressing in two different directions and may be defined as a split deflected light beam. This may be useful in a variant that comprises referencing means to calibrate the spectrum when the spectrometer is in operation.

The spectrometer 1 of the invention comprises at least one continuous-shaped filter element 40 having a narrow spectral band, defined hereafter as filter element 40, that is arranged between said optical layer 2 and said plurality 50 of photodetectors 52a-52n. Said filter element 40 defines a plurality of different filter portions 40a-40n that have different peak transmission wavelengths λ1-λn for each of said deflected light beams 12a-12n. In a typical example the filter element 40 has a transmission spectral band of less than 50 nm for normal incident light at any location of the filter element 40.

The continuous-shaped narrow spectral band filter element 40 is preferably made of a single sheet that may comprise different coating layers. In a preferred embodiment the filter element is a homogeneous interference filter that may be arranged on a support such as a glass or plastic sheet. Said filter portions 40a-40n may be continuous portions or may be separated by portions that have only a supporting function. Said filter may comprise openings or structures allowing fixing the filter element 40 between said optical layer 20 and the array 50 of photodetectors. Assembling filter sheets and layers comprising arrays of microelements and arrays of photodetectors are known to the skilled in the art and are not further described here.

FIG. 4 shows a schematic lateral view of a cross section of an exemplary realization of spectrometer 1 comprising an optical layer 2 that provides an array of micro-optical elements that are each configured to limit its field of view and at the same time provide each a deflected beam 12a-12n. Further are described embodiments in which the angular limitation and the deflection are realized by an optical layer 2 that comprises at least two distinct separate layers 20, 30. It is understood that each of said at least two distinct separate layers 20, 30 may comprise several layers comprising micro-optical elements.

It may be immediately recognized to a skilled person that the spectrometer of the invention has several important advantages and improvements relative to the spectrometers of prior art, such as the one described in WO 2016/125165, which are commented hereafter.

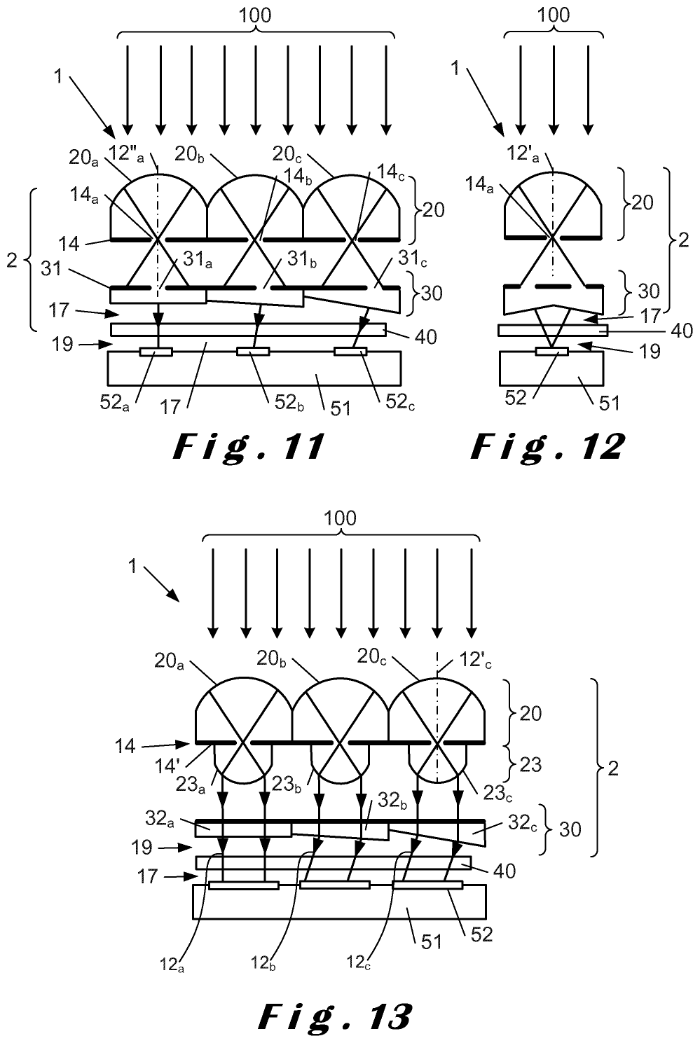

First, the spectrometer 1 of the invention requires only one or a few different narrowband filters while being able to address a large number of spectral channels The exemplary embodiments of FIGS. 4-9 and FIGS. 11-15 show configurations based on a single interference filter 40, which has over its whole aperture the same spectral transmittance for light beams that would be incident perpendicular to its plane. In the case of the spectrometer of the invention, light is incident on the filter 40 at a variety of angles, providing transmitted light beams though the filter 40 having different peak transmission wavelengths λ1-λn.

Secondly the optical system consists in a compact stack of a few—typically 2 to 5—layers comprising micro-optical elements. Said stack may have an overall thickness smaller than 1 mm, even smaller than 500 μm, preferably smaller than 100 μm. The layer stack can be directly processed on a wafer comprising for example an image sensor, using well knows techniques such as replication techniques using for example UV imprint. Also, masters to replicate the micro-optical structures may be performed with standard photolithography.

Thirdly, because the optical layer 2 is configured to select portions of the incident light and deflect on said filter element 40 and said detector array 50, this removes drastically constraints on the design and fabrication tolerances of the micro-optical elements that may be batch processed.

The combination of the essential features of the spectrometer 1 would not be achievable with any variant of spectrometers of prior art, such as the spectrometer described in WO 2016/125165. For example the spectrometer described in WO 2016/125165 is based on a plurality of adjacent chambers that each comprises a separate and different interference filter, each interference being associated with at least one lens that needs to have a long focal length because a light diffusor needs to be arranged at the entrance pupil of that lens. Furthermore, in order to minimize the number of interference filters, which is mandatory in such a system, the lens needs to have a high numerical aperture (NA) which imposes unacceptable spherical aberrations, and would drastically increase the device complexity and cost in order to correct them. On the other hand if one wants to reduce such aberrations, a small entrance pupil for each lens is requires in order maximizing the imaging quality in angular space, which implies large light losses and a high noise level. Also the assembly of the different focusing elements and the different interference filters is complex and therefor expensive. Using the spectrometer described in document WO2016/125165, for a given image sensor pixel width w and a total number n of spectral channels, the lens diameter D is approximately w*n. For a single filter, the total width W of the device is equal to w*n. The F-number, symbolized as F, of a lens is defined by the ratio of its focal length f to its diameter. D The lower this F-number, the higher the NA and the fabrication complexity. The total height h of the device is a direct function of the lens focal length: h˜F*D=rw*n. The form factor of the spectrometer is therefore W/h˜1/F, which should be maximized for applications requiring integration in a flat device. In order to maximize the form factor, the F-number should be minimized, which implies high challenges. Typically the F-number is technologically limited to >2 for micro-optical components in order to limit optical aberrations, corresponding to an upper bound of 0.5 of the form factor. All pixels of the sensor should be used in order to maximize the signal. For an image sensor size of 3 mm and the height of the optical system would be in the order of 6 mm.

To the contrary of the spectrometer of WO2016/125165, the device of the invention, each micro-optical element covers a finite number X of pixels of width w of the image sensor, so that its diameter D=X*w. The number X of said pixels may be 1. The total width of the device 1 is therefore dependent on the number of micro-optical element, knowing that each micro-element is responsible for a spectral channel. Given n spectral channels, the total width of the device is therefore W=n*D=n*X*w. The total height of the device is a direct function of lens F-number: h˜F*D=f*X*w. The form factor of the device is therefore W/h˜n/F. Although the F-number is technologically limited, the form factor of the device can be increased by increasing the number of spectral channels. Typically the F-number is technologically limited to >2 for micro-optical components in order to limit optical aberrations, corresponding to an upper bound of 15 of the form factor for 30 spectral channels. For an image sensor size of 3 mm, the height of the optical system would be in the order of 200 μm.

There is no way to solve the problem that is the object of the present invention, with a spectrometer such as described in device of WO 2016/125165 or similar spectrometers of prior art. The device of WO 2016/125165 would not allow to solve the problem as it faces fundamentally contradictory optical and performance requirements in view of the required very small thickness and low cost of the spectrometer.

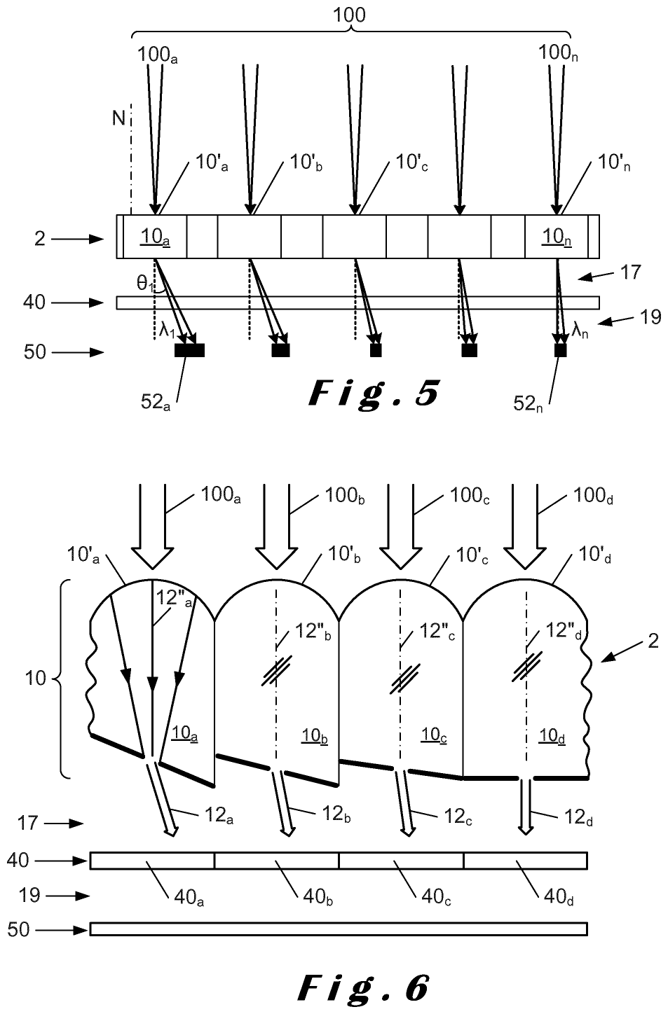

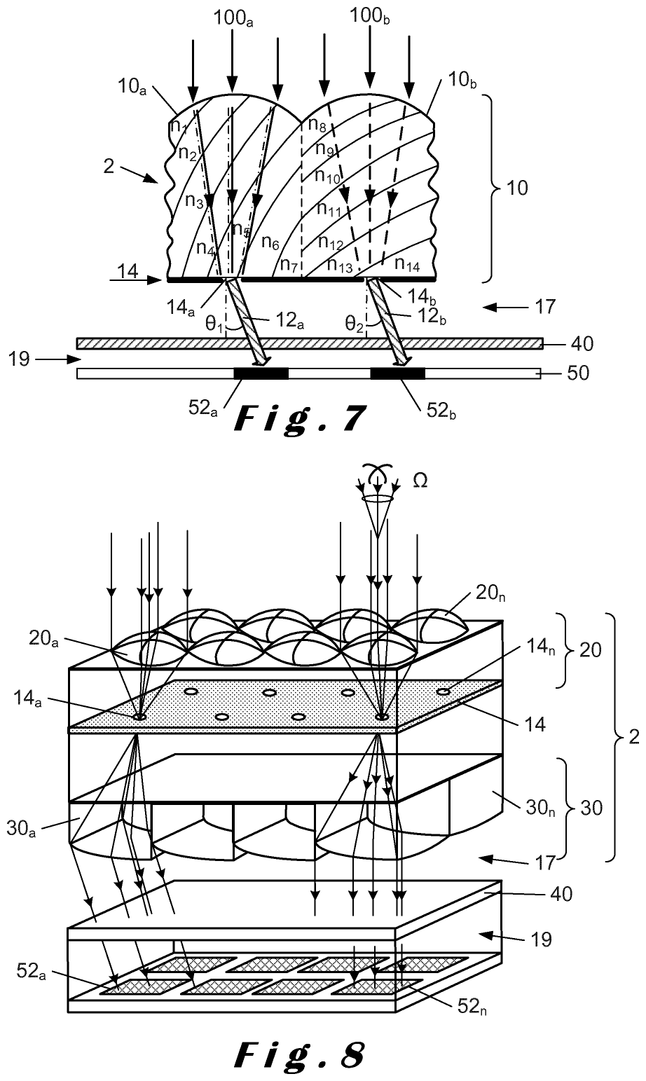

In embodiments the optical layer 2 may be a single layer that provides said angular filter while at the same time providing a deflection of the transmitted beams 12a-12n. FIG. 6 shows such a realization in which said optical layer 2 comprises an array 10 of microlenses 10a-10n which have a rear surface that are inclined relative to the plane of said filter element 40, and that comprise an opaque layer having pinholes facing said microlenses. In another variant, illustrated in FIG. 7 the optical layer 2 is made of an array of microlenses that have a plurality of layers having different indices of refraction, or a gradient of refractive indices. In such an embodiment an opaque layer having pinholes, facing said microlenses and parallel to said filter element 40, is arranged to the rear side of the microlenses.

In a preferred embodiment, said optical layer 2 comprises at least one angular filter layer 20 and at least one deflecting layer 30. Said angular filter layer 20 comprises an array of angle limiting optical elements 22a-22n that are each configured to limit the acceptance angle of transmitted light 12a-12n through said optical elements 20a-20n Said deflecting layer 30 comprises deflecting optical elements 30a-30n configured to deflect and direct each of said deflected light beams 12a-12n onto at least one of said photodetectors 52a-52n.

The invention provides different ways to realize and combine said at least one angular filter layer 20 and said at least one deflecting layer 30 and are now described in detail.

In an embodiment said at least one deflecting layer 30 is arranged between said at least one angular filter layer 20 and said plurality 50 of detectors 52.

In a variant said at least angular filter layer 20 is arranged between said at least one deflecting layer 30 and said plurality 50 of detectors 52. It is understood that in variants more than one angular filter layer 20 and/or deflecting layer 30 may be implemented in the optical layer 2. The thickness t of said spectrometer, defined in the direction of a normal to said light collecting surface 11 is preferably less than 3 mm and its largest width, defined in the plane of said light collecting surface 11 is less than 10 mm.

In embodiments said optical layer 2 may be configured so that at least two of said photodetectors 52 receive different and partially overlapping spectral portions of light provided by an incident light beam 100.

The field of view of the spectrometer of the invention covers preferably a total spatial solid angle Ω that is less than 400 square degrees, preferably less than 225 square degrees, more preferably less than 100 square degrees, even more preferably less than 25 square degrees, even more preferably less than 9 square degrees.

In an embodiment illustrated in FIG. 5 the geometrical distribution said photodetectors 52a-52n in the plane of said plurality 50 of photodetectors 52a-52 is non uniform, and in variants the photodetectors 52a-52n may have different shapes and/or sizes.

In embodiments said optical layer 2 may be realized by the assembly of at least one angle limiting layer 10 and at least one separate deflection layer 20, to the contrary of embodiments illustrated on FIG. 6 and FIG. 7 wherein the optical layer 2 provides at the same time an angular and deflection selection function In embodiments said at least one deflection layer 20 and said filter element 40 are separated by a first separation layer 17. In other embodiments said filter layer 40 and said detector layer 50 are separated by a second separation layer. Said first and/or second separation layer may be air or may me made of another substance such as a polymer layer.

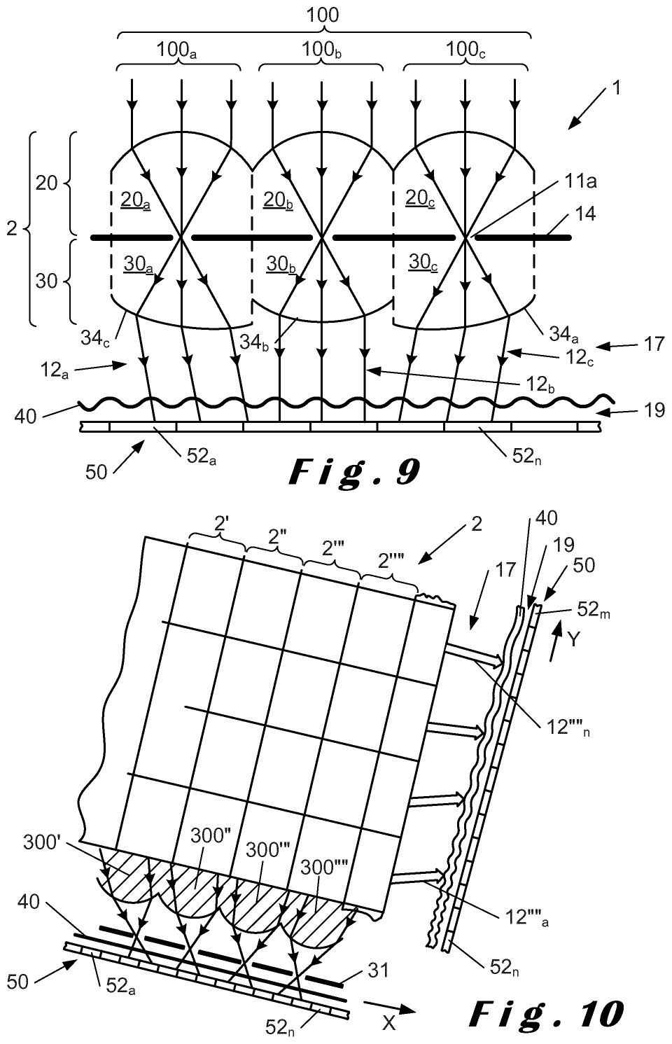

In embodiments, illustrated in the examples of FIGS. 9-13, angular selecting optical elements 20a-20n may be configured that have only a function to limit the portion 12a-12n of an incident light beam 100 that is transmitted through the spectrometer 1. In embodiments said angular filter layer 20 comprises at least 20 angular limiting optical elements 20a-20n.

In an embodiment said angular filter layer 20, comprises at least one opaque layer 14 comprising at least one array of pinholes 14a-14n. In variants said pinholes 14a-14n may be replaced by microslits. Said pinholes or microslits may be situated on said central axis 12″a-12″n or may be decentered relative to said central axis 12″a-12″n.

In an embodiment, illustrated in FIG. 13 said angular filter layer 20, comprises said at least two arrays 20, 23 of microlenses that have opposite oriented microlens curvatures. In the embodiment illustrated in FIG. 13, a first array of microlenses 20a-20n and an array of pinholes 14a-14n, or microslits, is used to perform the angular filtering and the second array of microlenses 23a-23n is used to collimate the transmitted beams 12a-12n. The second array of microlenses 23a-23n is in this configuration adapted to perform a beam shaping function of the incident light-beams 100a-100n incident on the angular selective optical elements 20a-20n in order to provide to the optical filter preferable beam shapes. It is understood that other micro-optical elements may be used for beam-shaping at any place in the spectrometer 1.

The at least two arrays of microlenses 20a-20n; 23a-23n may be decentered in respect to each other.

In a variant each of said pinholes 14a-14n or microslits is situated on said central axis 12′a-12′n. In a variant each of said pinholes 14a-14n, or microslits, is not situated on said central axis 12′a-12′n.

In embodiments the opening and/or the position of said array of pinholes 14a-14n or said array of microslits may be changed by electronic means.

In a variant that is not illustrated, said array 20 of angular limiting optical elements 20a-20n comprises an array of microlenses, the microlenses being diffractive microlenses such as Fresnel microlenses, binary diffractive microlenses, metasurface-based microlenses, or cascaded metasurface-based microlenses.

In a variant not illustrated, said array 20 of angular selective optical elements 20a-20n comprises at least one array of embedded microlenses. Embedded microlenses may for example be realized at the interface between two materials having different refractive index and not being at the interface between a material and air or vacuum. Such an embedded realization may be more robust than non-imbedded angular selective optical elements 20. Various polymer, sol-gels and glasses are transparent and exhibit different refractive index and may be suitable for this embedded implementation.

Also, in embodiments each of said angular selective optical elements 20a-20n may comprise a reflective surface. Reflective configurations allow obtaining quasi-achromatic angular selective optical elements 20a-20n as not relying on refraction and/or diffraction for their main optical function.

In an embodiment at least a portion of said angular selective optical elements 20a-20n is configured according to a catadioptric configuration. In a variant each of said angular selective optical elements 20a-22n is configured according to a catadioptric configuration.

In an embodiment at least a portion of said reflective configuration is a micro-Cassegrain configuration. Preferably the micro-reflective configurations such as the micro-Cassegrain are embedded into a transparent material, avoiding the reflecting surfaces to be exposed to the environment and to possible scratches or other degradation.

In an embodiment illustrated in FIG. 9 at least one deflecting layer 30 comprises an array of microlenses 30a-30n that is decentered relative to the angular limiting microlenses 20a-20n. In an embodiment illustrated in FIG. 11-FIG. 13 at least one deflecting layer 30 comprises an array of microprisms 32a-32n. In variants said deflecting layer 30 may comprise an additional opaque layer comprising pinholes and/or microslits.

In an embodiment illustrated in the schematic cross-section of FIG. 11, a spectrometer 1 is based on an optical filter 40 which has a significant angle dependent transmission. An adequately designed resonant grating shows e.g. a strong angular dependent transmission spectrum.

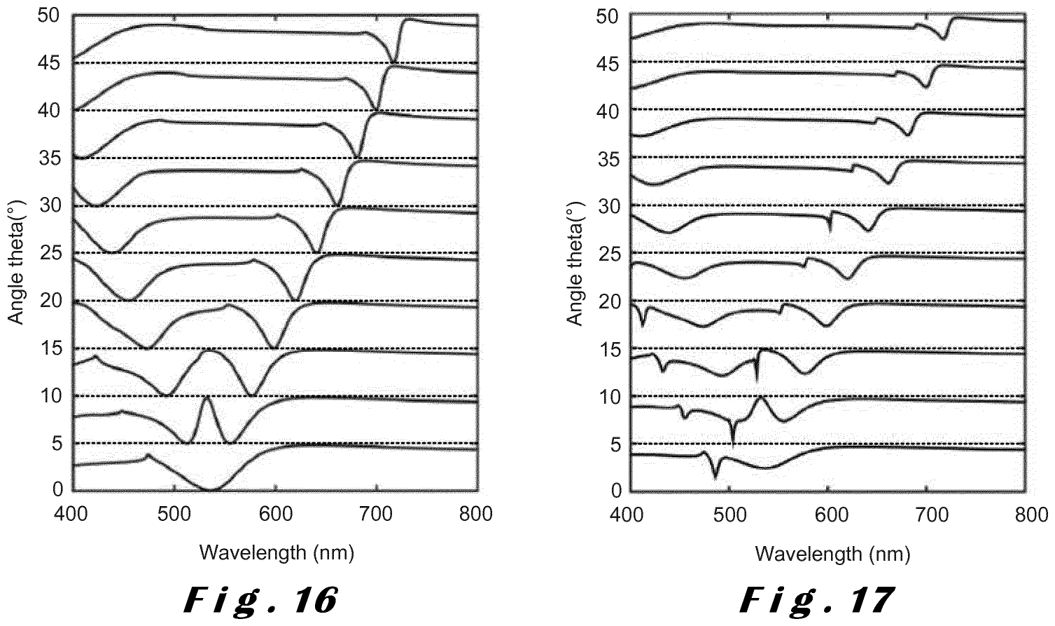

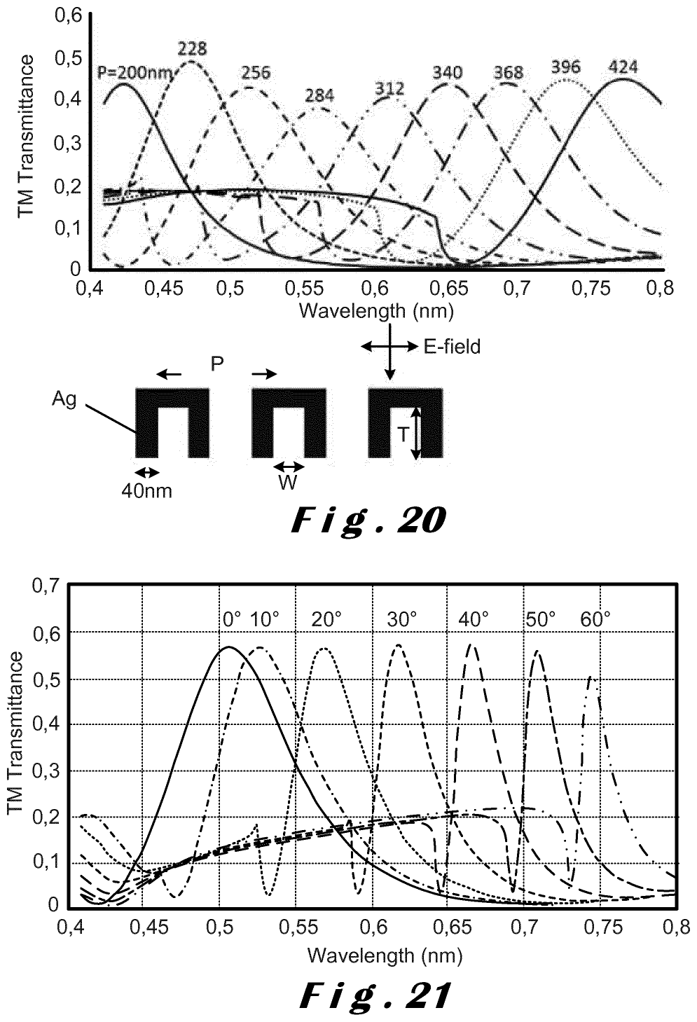

In exemplary realisations such as shown in FIG. 16, a resonant waveguide grating has a shift of 120 nm of its resonance wavelength when the incidence angle is adjusted from 0° to 30°, and 200 nm shift from 0° to 50°. A plasmonic grating is shown in FIG. 21, for which a shift of 120 nm of the resonance wavelength is observed when the incidence angle is adjusted from 0° to 30°, a 200 nm shift from 0° to 50°, and a 230 nm shift from 0° to 60°. Typically, at least 50%, preferably more than 75%, of the deflection angles θ1-θn are superior to 1°. In variants preferably at least 80%, even more preferably at least 90% of the light beams 12a-12n are deflected. The deflection angles θ1-θn can typically range up to 60° but are not limited by this value. Preferably, the deflection angles θ1-θn range up to 30° in order to minimize aberrations which would induce an increase in solid angle of the transmitted light beams 12a-12n.

In order to illuminate the angle dependent filter element 40 with light at different angles, the angles of the incoming light beam 100 of interest are first limited by preferably a microlens array 20a-22n and an array of pinholes or microslits 14a-14n to select only one angle of incidence. This is illustrated in the example of FIG. 8. In embodiments, illustrated in FIG. 11, a second additional array 31 of pinholes or microslits 31a-31n is preferably used to select light provided from different generated angles. The more the second aperture 31a-31n opening is aligned with the first apertures 14a-14n the larger is the angle of the light passing the second aperture 31a-33n, and so the angle of the transmitted light beams 12a-12n impeding on the optical filter 40, leading to a significant angle dependent transmission along the filter element 40.

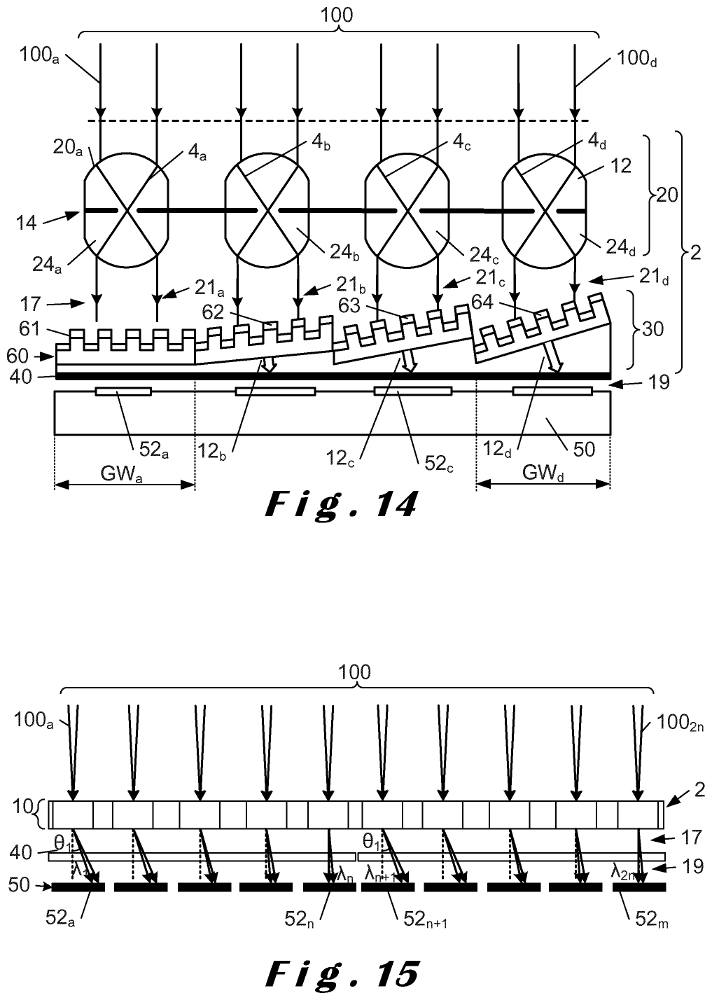

In an embodiment at least one of said deflecting optical elements 30a-30n is a diffraction grating 61-64, for example a binary diffraction grating arranged in a grating array 60. In an advantageous arrangement, schematically illustrated in FIG. 14, at least one of said diffraction gratings 61-64 is not parallel with said filter element 40.

In variants at least one of said angle limiting optical elements 20a-20n and/or said deflecting optical elements 30a-30n comprises a reflective surface. In variants each of said angular limiting optical elements 20a-20n and/or said deflecting optical elements 30a-30n is configured according to a catadioptric configuration, which may be a Cassegrain configuration.

In embodiments said angular filter layer 20 and/or said deflecting layer 30 may comprise an LCD layer. In a variant, said angular filter layer 20 and/or said deflecting layer 30 may comprise a plurality of refractive index layers of which each refractive index may be modified by external means, such as the application of an electrical field. Such external means may also be configured to change the gradient of gradient indices of micro-optical elements 10a-10n, such as the gradient layers illustrated in FIG. 5.

It is also understood that said angular limiting optical elements 20a-22n may be separated by light absorbing means, such as opaque micro-baffles, so that no light can be transmitted between different angular limiting optical elements 20a-20n. It is also understood that said deflecting optical elements 30a-30n may also be separated by light absorbing micro-baffles so that no light can be transmitted between different angular limiting optical elements 30a-30n. In variants, not shown in figures, a layer comprising at least one array of light absorbing means may be arranged between said optical layer 10 and said filter element 40 and/or said detector layer 50.

In variants of the spectrometer 1 of the invention at least a portion of said microlenses are made of plastic or polymer or sol-gel or SiO₂. Alternatively, the microlenses are made of silicon for operation on the infrared range of other materials suitable in the infrared range. Such microlenses are well-known and widely used in wafer-level optics and optical foils and sheets. They can be made with different layouts and different microlens profiles, such as spherical or aspherical profiles. They can be replicated on transparent substrate, etched in transparent substrate such as glasses, fused silica or silicon or laminated as thin polymer foils.
The continuous-shaped narrow spectral band filter element 40 is now described in detail.

In an embodiment said filter element 40 is a single interference filter. In a variant the interference filter may be made of a single sheet comprising a plurality of different interference layers

In an embodiment said filter element 40 is a resonant grating. Said filter element 40 is an array of resonant gratings.

In an embodiment said filter element 40 is a chirped resonant grating.

In an embodiment said filter element 40 comprises at least one plasmonic filter based on local resonances.

In an embodiment said filter element 40 comprises at least one plasmonic filter based on surface plasmon-polaritons. Invariants, at least a portion said optical filter 40 comprises at least one plasmonic filter based on surface plasmon-polaritons. The plasmonic filter 40 is designed in such a way to transmit or reflect a portion of visible light, i.e. a wavelength band. The plasmonic structures have different parameters in order to transmit or reflect different wavelength bands.

FIGS. 16-21 show experimental results obtained with spectrometers 1 of the invention.

For an example of realization, an array of aluminum plasmonic nanostructures shows a band of transmission, illustrated in FIG. 20, at a wavelength range depending on the parameters of the structure. The simulations have been performed using the rigorous coupled wave analysis. The surrounding material is a sol-gel with a refractive index ranging from 1.54 to 1.51 in the wavelength range 400 nm-800 nm. The TM transmittance curves have been calculated for different periods P and for different widths and different vertical height T

The designed plasmonic structures can be fabricated using nano-imprint lithography of a binary grating in solgel, followed by two coatings of aluminum, one from each side of the grating lines, with a given angle (here 70°). Due to the self-shadowing from the grating shape, the aluminum is deposited only of the top and the sidewalls of the grating lines, generating the shape in the schematic of FIG. 20 After evaporation, the structures can be coated with a layer of sol-gel to provide a protection from the environment.

The following table I shows the structure parameters corresponding to the simulated spectra in FIG. 20. The parameters period P, width W and thickness T have been designed in such a way that they can be fabricated using the same evaporation angle and aluminum thickness. This way, an optical filter 40 comprising these elements can be fabricated with only two evaporation steps.

| P [nm] | W [nm] | T [nm] |
|---|---|---|
| 200 | 100 | 37 |
| 228 | 114 | 41 |
| 256 | 128 | 47 |
| 284 | 142 | 52 |
| 312 | 156 | 57 |
| 340 | 170 | 62 |
| 368 | 184 | 67 |
| 396 | 198 | 72 |
| 424 | 212 | 77 |

Table I Combination of values for P, W and T, each combination corresponding to one of the curves in FIG. 20.

Plasmonic filters can for example be realized using nanohole arrays, for which the transmission peak wavelength can be calculated by matching the surface plasmon momentum to the momentum of the diffracted wave:

$$λ = P \sqrt{\frac{{ϵ}_{m} {ϵ}_{d}}{{ϵ}_{m} + {ϵ}_{d}}} ( \frac{1 - sin θ}{\sqrt{{i}^{2} + {j}^{2}}} )$$

In this formula, P is the pitch of the hole array, the incidence angle, (i, j) the diffraction orders in the plane of the nanohole array determining the in-plane plasmon momentum, εₘ the metal permittivity and Ed the adjacent dielectric permittivity. The peak wavelength can be therefore tuned with the incidence angle. This was explained in detail for a normal incidence by C. Genet, M. P. van Exter, J. P. Woerdman in Optics Communications vol. 225 (2003) pp 331-336.

FIG. 21 shows transmission spectra of a plasmonic filter with parameters according to Table 1 and period 256 nm, at incidence angles from 0°, 10°, 20°, 30°, 40°, 50°, 60°. The peak wavelength shifts from 510 nm to 740 nm.

For the case of a spectrometer 1 using a resonant waveguide grating filter 40 using varying oblique transmission, an example of such a resonant waveguide grating optical behavior is shown in FIG. 16 and FIG. 17, various other dielectric based optical filters as disclosed in the scientific literature might be used instead. Transmission spectra of such resonant grating filters are simulated by rigorous coupled wave analysis (RCWA). For a reference see e.g. the recent article by B. Gallinet et al. Laser Photonics Review 9(6) p. 577 (2015), “Numerical methods for nanophotonics: standard problems and future challenges”. FIG. 16 shows the simulated transmission for TE polarized (electric field parallel to the grating orientation) of light illuminating a rectangular shaped one-dimensional resonant grating for various incidence angle theta. A grating period of 310 nm, a grating depth of 70 nm, a duty cycle of 0.5 (the grating lamella is half the grating period) and a zinc sulfide (ZnS) coating of 70 nm is assumed. A classical grating illumination set-up is chosen (the plane of incidence is perpendicular to the grating lines) and the incidence angle theta is the angle against the grating normal. As dielectric substrate, holding the grating, an ultraviolet (UV) curable ormocer resin Ormocomp (micro resist technology, Germany) is chosen. The ZnS grating is open towards air (superstrate). The simulated spectra are carried out for 10 angle of incidence from theta=0° to theta=45° with a step of 5°. One resonance is observed for theta=0° at approx. 535 nm, which splits up into two resonances for larger incidence angles. The FIG. 16 shows that resonances occur between 400 nm and 700 nm for the chosen grating for incident angles varying between 0° and 45°. For the later data processing and the extraction of the spectrum these characteristic spectral features (resonances) are used as input parameters.

Strong spectral filtering is achieved based on resonant gratings as described and with spectral properties as illustrated in FIG. 16 for linearly polarized light and thus require a polarizer. The angle dependent transmission of the same resonant grating is also simulated for unpolarized light and the results are shown in FIG. 17. FIG. 17 is identical to FIG. 16 but for unpolarized light incidence. The spectral features of the shown spectra are less pronounced. A conical illumination or a 2-dimensional grating design might contribute to make the spectral features stronger for both incident light polarization and so without the implementation of a polarizer.

In the past years an increasing number of spectrometers have been described, which rely for the extraction of the spectrum from the raw filtered data on a variety of signal processing techniques, including compressed sensing, singular value decomposition or non-negative constrained least-squares algorithms (C. C. Chang et al. in Optics Express 16(2) p. 1056 (2012) “On the estimation of target spectrum for filter-array based spectrometers”).

In order to extract high resolution spectral information, spectra filters with narrowband spectral features are needed. For that reason random filters have been studied as outlined in by J. Olivier et al. in “Filters with random transmittance for improving resolution in filter-array-based spectrometers”—in Optics Express 21(4) p. 3969 (2013) or in the compressed sampling (sensing) tutorial by E. J. Candès and M. B. Wakin in “An introduction to compressive sampling”—IEEE Signal Processing Magazine 25 21 (2008). E. J. Candès states: “In this review, we have decided to highlight this aspect and especially the fact that randomness can—perhaps surprisingly—lead to very effective sensing mechanisms”. Compressed sensing may be especially useful to identify the position of one or a few spectral lines impeding on the light collecting surface 11 using a limited number of photodetectors 52a-52n.

Resonant gratings can be designed to have many resonances with e.g. a thick waveguide layer as illustrated by R. Magnusson in “Spectrally dense comb-like filters fashioned with thick guided-mode resonant gratings”—Optics Letters 37(18) p. 3792 (2012) or holding multi-periodic or deterministic aperiodic structures as disclosed by L. T. Neustock et al. in “Optical Waveguides with Compound Multiperiodic Grating Nanostructures for Refractive Index Sensing”, Journal of Sensors ID6174527 2016.

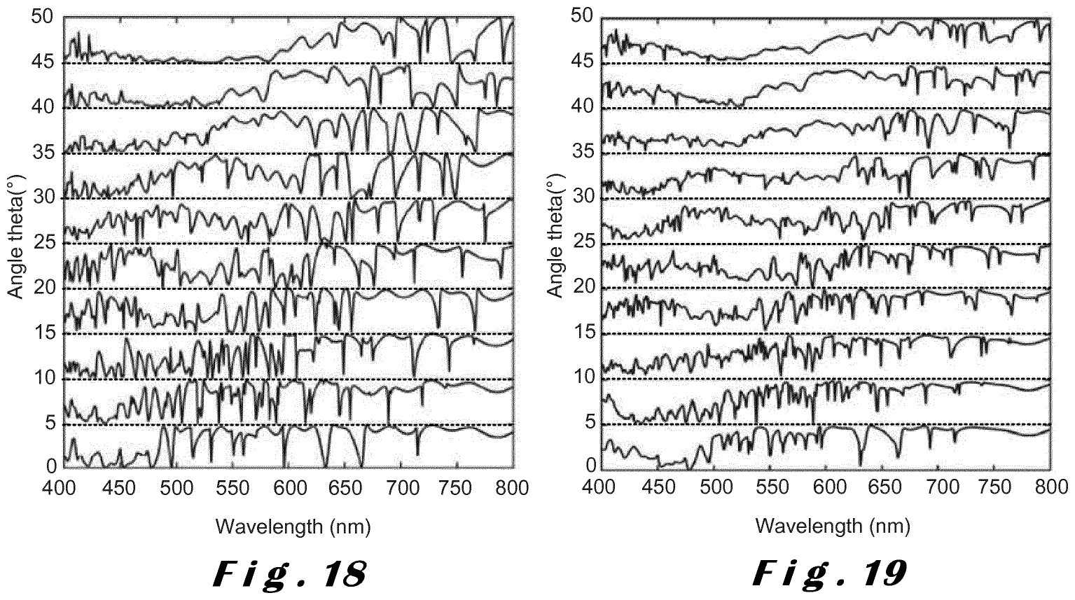

FIG. 18 and FIG. 19 illustrate the spectral feature richness increase with the waveguide thickness, with the RCWA computed transmission spectra in TE polarization in FIG. 18 and for unpolarized light in FIG. 19 The resonant waveguide grating has the same structure than the one described above for FIGS. 16 and 17 but for a thicker waveguide thickness, the ZnS waveguide thickness of 1000 nm instead of 70 nm.

In a variant, the transmission optical filters 40 could be made more polarization insensitive by implementing 2-dimensional including hexagonal gratings such as disclosed by Y. Li et al. in “Guided-Mode Resonance Filters for Wavelength Selection in Mid-Infrared Fiber Lasers”—IEEE Photonics Technology Letters 24 p. 2300 (2012).

In a variant, the angle sensitivity can also be tuned with e.g. multi-periodic grating such as disclosed by A. Mizutani et al. in “Wave Localization of Doubly Periodic Guided-mode Resonant Grating Filters”—Optical Review 10 p. 13 (2003). In a variant, illumination under e.g. conic angles could be used such as disclosed by D. W. Peters et al. in “Angular sensitivity of guided mode resonant filters in classical and conical mounts”—SPIE 8633 (2013).

All the variants listed above may be implemented as optical filter 40 that could be preferably implemented and optimized to realize the spectrometer 1 according to various specifications.

In a variant, the spectral filters may be realized with Fabry-Perot Resonators such as for example described by Lambrechts and all in “A CMOS-compatible, integrated approach to hyper- and multispectral imaging”. In a variant, the spectral filter could be made with a combination of a resonant waveguide-grating and a Bragg reflector or multi-waveguides resonant waveguide-gratings—in which several waveguides and spacers are stacked on a grating.

Said array 50 of photodetectors 52 comprises at least six photodetectors, but in practice the number of photodetectors 52a-52n in the detector array 50 is typically several tens and can be higher than 100. In an embodiment, the number of photodetectors is equal to the number of the angular selecting optical elements. In a variant, the number of photodetectors is larger than the number of angular selecting optical elements. In a variant, the number of photodetectors in an integer times the number of angular selecting optical elements. Alternatively, the number of photodetectors might be lower than the number of angular selecting optical elements, reducing the amount of data generated by the spectrometer 1 for a given number of angular selecting optical elements.

In an advantageous embodiment the spectrometer 1 according to the invention comprises at least one light source arranged in between said virtual light collecting surface 11 and the backside of the substrate of the photodetector layer. In an exemplary execution such light source is arranged in the layer 50 comprising said photodetectors 52a-52n and configured to send at least one light beam through said optical layer 2 to illuminate a sample to be analyzed. In a variant an LED light array may be used for that and the light array may be arranged so that at least one of its emitted light beams, in operation, is transmitted through at least one of said angle limiting 20a-20n and/or light deflecting 30a-30n elements.

In an exemplary execution the spectrometer 1 of the invention may comprises signal processing means to process data provided by an electric circuit that is integrated in or on the substrate 51 of the array 50 of photodetectors 52. Said processing means may be configured to allow reconstructing at least a portion of the spectrum of the light provided by an incident light beam 100.

The light collecting surfaces of the detector array define a detector plane. It is understood that in some cases of realization the light collecting surfaces of the detector array 50 may define a curved surface, for example in the case of very thin detectors that are realized on a flexible substrate as currently is possible to realize by existing technologies. Said detector plane has to be understood as at least locally flat at the detector array surface portion that faces each of said angular deflection optical elements 32a-32c. In variants, said detector layer 50 and said optical layer 10 may be curved layers and may have a different curvature.

The spectrometer 1 of the invention has a predefined maximal thickness t, defined perpendicular to said light collecting surface 1a. It is understood that the thickness t may vary for different locations in the spectrometer. As a non-limiting example, it may be that the maximal width is 5 mm in a first portion of the spectrometer and that the other portion of the spectrometer has a width of less than 4 mm. The thickness of the thin spectrometer 1 of the invention may also vary continuously over its width, i.e. from one lateral side to another lateral side of the detector array.

In most examples of realization a virtual light collecting surface 11 is coincident to the entry surface 2a of said optical layer 2. In other variants the light collecting surface may be the incident light surface of a protection layer of the spectrometer 1, arranged to the incident light side of the spectrometer 1.

The thickness t of the spectrometer may be less than 4 mm, preferably less than 3 mm, even less than 2 mm and in the case of an ultra-flat spectrometer 1, the thickness may be lower than 1 mm, even lower than 500 μm

It is understood that the thin spectrometer may comprise a variety of structures such as for example at least one whole extending from said entry surface 2a to said substrate or support of the detector array 50. Such holes may for example have assembly purposes.

In configurations it is possible allow to provide means to dynamically modify the effective angular selectivity of the spectrometer 1, either on all of its spectral channels or on a portion of its surface. In a variant, the effective pinhole aperture may for example be moved laterally over time to gather imaging information in addition to spectral information on the incident light.

It is also generally understood that any of the separation layers of the arrays of the spectrometer, such as the gap layers 17, 19 may comprise optical elements such as a light shutter blocking all the light to the whole detector array 40 or a linear polarizer or a retarder layer or a tunable retarder layer such as a liquid crystal cell in order to improve the performance of the spectrometer. In variants, light sources may be arranged in said gap layers 17, 19.

In embodiment's opaque layers 14, 31 of the spectrometer, comprising arrays of pinholes or slits, may be made by any at least partially light absorbing layer, such as a black coating or a nanostructured metallized surface. As an example, a black absorbing material can be realized with nano-structuration and metallization in so-called Moth-eye design with two dimensional subwavelength structures metallized and configured to absorb most light impeding on them. Alternatively, black paint of a carbon-based black material can be used or coated on a light blocking layer, as well as an absorbing metal oxide such as chromium oxide.

Preferably said optical filter element 40 is configured so that at least six of said transmitted light beams 12a-12n have different spectra, induced by different spectral filtering, and are provided by incident light beams 100a-100n have the same or different total spatial solid angle θ. For example, the number of said angular selective optical elements 12a-12n pointing to the same or quasi-identical total spatial solid angle θ may be much higher than 6 and may be higher than 10, higher than 25 or higher than 50. For calibration purposes at least two transmitted light beams may have the same angular distribution and have the same spectral content and intensity.

The spectral resolution Δλ of the spectrometer 1 of the invention, in its whole spectral width, is less than 50 nm, preferably less than 20 nm, even preferably less than 10 nm. The spectral resolution in different spectral portion may be different, for example different in the blue and red regions or in the visible and near-infrared regions.

In variants, the spectrometer may comprise a 2 dimensional array of detectors 52 and/or a 2 dimensional array 20 of angular selecting optical elements 20a-20n and/or a 2 dimensional array 30 of angular deflection elements 30a-30n. FIG. 10 that is commented further is an illustration of a 2 dimensional configuration of a focal plane spectrometer comprising one array of spectrometers spectrometer in which a detector array 50, an array 20 of angular selective elements 20a-20n and the optical filter 40 have substantially the same two-dimensional shape and dimension. This is not necessarily so. In variants only one of said detector array 50, the array 20 of angular selective elements 20a-20n or the optical filter 40 may have a two dimensional shape. The spectrometer 1 may comprise also at least two different linear shaped detector arrays in front of at least one of the arrays a color filter is arranged . . . . Said two dimensional shapes may be any shape, for example a hexagonal or circle shape.

In an embodiment the number of said photodetectors 52 facing each of said angular selecting optical elements 12 is equal to 1. In a variant, the number of photodetectors 52a-52n facing each of said deflecting optical elements 30a-30n may be more than 1.

In a practical realization the spectrometer comprises:
a 2 dimensional array 10 comprising 10×100 microlenses 20a-20n, said array 10 having a lateral dimension of 5×5 mm, each microlens 20a-20n has a square footprint of 50×50 microns, defined as the area of the deflected beam at the level of said photodetector array 50;
a pinhole array of which each pinhole, having a diameter of 10 μm, faces a microlens and the pinhole array is located in the focal plane of the microlens array or close to it, preferably less than 20% away from the focal distance f of the microlenses, i.e. at a distance located between 80% of focal distance f and 120% of focal distance f;
a filter array 40 having a lateral dimension of 5×5 mm and comprising 1000 color filter pixels;
a CMOS detector array 50 having 4000 detectors 52a-52n, each said microlens 20a-20n facing 4 detectors 52a-52n.

In a variant of a practical realization, the 1000 pixels of the filter element 50 may comprise 500 pairs of two identical filter elements 40 which are distributed over the two dimensional array of the color filter in order to have each filter not located adjacent to its identical color filter. Such design provides redundant information for each channel and is more robust to local and isolated fabrication defects.

It is understood that in all embodiments of the invention a portion of said optical layer 2 may be arranged to serve for referencing purposes. For example at least a portion of said optical layer may comprise apertures having a specific shape such as the shape of a cross and may be aligned facing a photodetector portion having the same or another specific shape, which may be for example a annular shape.

The invention is also achieved by a variant, illustrated in FIG. 10, which may be considered as a focal plane spectrometer. In such as variant said array 20 of angular selective optical elements 20a-20n are arranged in an array of single two dimensional array and arranged in various groups so that each group of angular selective optical elements have identical total spatial solid angles θ of the incident light beam 100 being transmitted to the transmitted light beams 12a-12n and so that each group is configured in a spectrometer 1, and that the angular selective optical elements located in different groups of the array have different said total spatial solid angle of incident light beams 100a-100n.

In an embodiment, said groups of angular selective optical elements 20a-20n of the array of angular selective optical elements 10 are located along a first direction of said array of the focal plane spectrometer and various groups are separated along a second direction different than said first direction. Said first and second directions may be orthogonal as illustrated in FIG. 10.

The focal plane spectrometer 1 may comprise imaging forming elements. There exist a wide variety of image forming elements that may be arranged in a focal plane spectrometer, also defined as imaging spectrometer. A summary of possible configuration that may comprise the spectrometer of the invention are summarized in: Hagen, M. Kduenov, “Review of snapshot spectral imaging technologies”, Optical engineering, SPIE September. 2013, pp. 090901-1 to 23

In the imaging spectrometer illustrated in FIG. 10, spectral analysis is performed over the Y axis and imaging in done on the X axis to realize a 1 dimensional multispectral camera. FIG. 10 shows a schematic top view as well as two cross section schematic views over the X and Y axis. In FIG. 10, only 4 groups of angular selective optical elements are illustrated that are each located along said Y axis are located next to each other along said X axis, the 4 groups of angular selective optical elements together with said optical filter 40 and said array 50 of photodetectors 42 are constituting 4 linear spectrometers, comprising each a linear shaped optical layer 2, 2′, 2″ and 2′″ pointing to different directions.

In an example illustrated in FIG. 10, an array of microlenses and an array 14 of pinholes 14a-14n constitute an array 20 of angular selective optical elements 20a-20n selecting the same angular range on the Y axis. The color filtering is performed over the Y axis by an inhomogeneous color filter 40 such as a gradient plasmonic filter or a chirp resonant waveguide-grating. On the opposite, over the X axis of the two dimensional array of the imaging spectrometer 1, various angular ranges are selected on the X axis providing imaging information, for example by having pinholes centers not aligned to the microlenses centers, while all the photodetectors 52a-52n located along the X axis (i.e. Having the same Y axis coordinate) perform a quasi-identical or identical spectral filtering. In the example illustrated in FIG. 10, only one axis is used for spectral analysis while the other axis is being used for one dimensional imaging. In order to provide the imaging function in the direction of the X-axis microlenses 300′-300″″ may be used such as illustrated in FIG. 10. In variants, a two dimensional array may be used only for spectral analysis, or a two dimensional array may have a complex pixelization allowing both spectral analysis and some imaging to be performed over the two axes of the array.

In variants, the spectrometer 1 may comprise more than 1 filter element. FIG. 15 illustrates a spectrometer 1 comprising two filter elements that direct the light onto two portions of the detector array. A first portion comprises photodetectors 52a-52n to detect the light beams 12a to 12n and a second portion comprises photodetectors 52n+1-52m to detect the light beams 12n+1 to 12m. The advantage of using more than 1 filter element 40 is to cover a much wider spectral range. It is understood that a portion of the spectrometer may be configured for the visible region, while at least another portion may be configured for another spectral range such as an infrared spectral range or a UV spectral range. Said optical layer may be configured to cover a wide spectral range and comprise portions that comprise materials that are transparent for specific wavelength rages such as the UV. This means that a portion of the optical layer 2 may be made of a polymer and at least another portion in glass or another material.

It is also understood that the micro-optical elements 20a-20n and the detectors 52a-52n may be arranged according to specific shapes such as concentric circles or other.

The various configurations disclosed in this document, and especially the various angular selective optical elements, the various beam redirected elements and the various optical filters disclosed can be arranged in many different assemblies and can be combined vertically or laterally. Spectrometers or imaging spectrometers or multispectral cameras can be realized based on one dimensional or two dimensional arrays comprising several of the above listed configuration or in multiple arrays configured to work together.

The various illustrations described here are targeting the angular selection light incident in a solid angle arranged around the normal to said light collecting surface 1a. However, it is straightforward to arrange this angular selection away from said normal N to the light collecting surface 11 if this configuration is preferable.

The invention is also achieved by a method to provide a spectrum by using the spectrometer 1 of the invention.

The method provides a spectrum of an emitted light beam provided by an illuminated sample and comprises the steps (a-e) of:
a. providing a spectrometer 1 as described;
b. directing said spectrometer to that said emitted light beam is incident on said virtual light collecting surface 1a;
c. converting the incident light beam into transmitted light beams 12a-12n;
d. deflecting said transmitted light beams 12a-12n on said detectors 52a-52n to provided electrical charges;
e. converting said electrical charges into electrical output signals, each electrical output signal being proportional to the light intensity of said incident light beams 12a-12n on said detector elements 52a-52n.

In an embodiment the method comprises the additional step f of:
f. converting said electrical output signals into a signal representing the spectrum of said incident light beam, said signal representing the spectrum of said incident light beam having at least 6 spectrally independent components.

In an embodiment the method comprises the additional step of:
g. performing a correlation between the electrical output signals so as to generate a signal representing the spectrum of said incident light beam.

In an embodiment the method comprising a calibration comprises the steps h-j of:
h. illuminating, before step a, said spectrometer 1 with a light beam having a known spectral composition;
i. generating a reference signal;
j. correcting, by using said reference signal, said electrical output signal provided by said step d.

In an embodiment, the method comprises an additional step l consisting in measuring the spectrum of the illuminant prior to measuring the spectrum of the incident light beam, and use it as a reference signal. In an embodiment of the method, said illumination is realized by light sources integrated between the detectors 52a-52n of the detector array 50. Said light sources may be semiconductor light sources and/or infrared light sources. Said light sources may be pulsed light sources. In a variant the spectrometer may comprises synchronous detection means that synchronize the light source emitting frequency with the detector array so as to provide lock-in detection. So the method may comprise means to realize such lock-in detection.

1-39. (canceled)

40. A spectrometer (1) to measure spectra of a sample, comprising an optical layer (2) comprising an array (10) of micro-optical elements (10a-10n) defining a virtual light collecting surface (11) having an orthogonal normal (N), and a plurality (50) of photodetectors (52a-52n) and at least one optical filter (40), said array (10) and said plurality (50) of photodetectors (52a-52n) defining a total field of view (Ω) to measure the spectra of said sample, wherein
each of said micro-optical elements (10a-10n) defines a local entry surface (10′a-10′n) and a central axis (12″a-12″n) parallel to said normal (N) and an input acceptance cone having a solid angle (Ω1-Ωn) of which the total aperture (α1-αn), defined in any plane comprising said central axis (10′a-10′n), is less than 30°, said cone having a predetermined spatial orientation relative to said central axis (10′a-10′n);
at least one of said micro-optical elements (10a-10n) is configured so that a portion (100a-100n) of a light beam (100) incident on said virtual light collecting surface (11) provides a deflected light beam (12a-12n) having a central light ray (12′a-12′n) that has a predetermined deflection angle (θ1-θn), different than zero and defined relative to the normal to the plane of said optical filter (40), directed onto at least one of said photodetectors (52);
at least one narrow spectral band filter element (40) is arranged between said array (10) of micro-optical elements (10a-10n) and said plurality (50) of photodetectors (52), said filter element (40) having a transmission function depending on the light incidence angle, defined relative to the normal of said filter element (40), and is configured so that said deflected light beam (12a-12n) is incident on its surface to the side of virtual light collecting surface (11)
said filter element (40) defines a plurality of different filter portions (40a-40n) that have different peak transmission wavelengths (λ1-λn) for each of said deflected light beams (12a-12n).

41. The spectrometer (1) according to claim 40, wherein said optical layer (2) comprises at least one angular filter layer (20) and at least one deflecting layer (30) said angular filter layer (20) comprising an array of angle limiting optical elements (20a-20n) that are each configured to limit the acceptance angle of transmitted light (12a-12n) through said angle limiting optical elements (20a-20n), said deflecting layer (30) comprising deflecting optical elements (30a-30n) configured to deflect and direct each of said deflected light beams (12a-12n) onto at least one of said photodetectors (52a-52n).

42. The spectrometer (1) according to claim 41, wherein said at least one deflecting layer (30) is arranged between said at least one angular filter layer (20) and said plurality (50) of detectors (52).

43. The spectrometer (1) according to claim 41, wherein said at least angular filter layer (20) is arranged between said at least one deflecting layer (30) and said plurality (50) of detectors (52).

44. The spectrometer (1) according to claim 40, in which more than 50%, preferably more than 75%, even more preferably more than 90% of said deflected light beams (12a-12n) have deflection angles (□1-□n) that are superior to 1° or 3°.

45. The spectrometer (1) according to claim 40, wherein the thickness (t) of said spectrometer, defined in the direction of a normal N to said light collecting surface (11) is less than 1 mm and its largest width, defined in the plane of said light collecting surface (11) is less than 3 mm.

46. The spectrometer (1) according to claim 40, wherein said optical layer (2) is configured so that at least two of said photodetectors (52) receive different and partially overlapping spectral portions of light provided by an incident light beam (100).

47. The spectrometer (1) according to claim 41, wherein said angular filter layer (20) comprises an opaque layer (14) comprising at least one array of pinholes (14a-14n) and/or an array of microslits.

48. The spectrometer (1) according to claim 41, wherein said angular filter layer (20) comprises at least one array (20′) of microlenses (20a-20n).

49. The spectrometer (1) according to claim 48, wherein said angular filter layer (20) comprises at least two arrays (21, 23) of microlenses (20a-20n; 23a-23n) comprising different microlenses.

50. The spectrometer (1) according to claim 49, wherein said at least two arrays (20, 23) comprise microlenses having opposite oriented microlens curvatures.

51. The spectrometer (1) according to claim 49, wherein said at least two arrays of microlenses are decentered in respect to each other.

52. The spectrometer (1) according to claim 48, wherein said each of said pinhole (14a-14n) and/or microslit is situated centered on said central axis (12″a-12″n).

53. The spectrometer (1) according to claim 41, wherein said deflecting layer (30) comprises an array of prisms.

54. The spectrometer (1) according to claim 41, wherein said at least one deflecting layer (30) comprises an opaque layer (14) comprising at least one array of pinholes (14a-14n) and/or an array of microslits (15a-15n).

55. The spectrometer (1) according to claim 40, wherein said filter element (40) is made of a substrate comprising a single interference layer stack.

56. The spectrometer (1) according to claim 40, wherein filter element (40) is made of at least two substrates comprising each a different interference layer.

57. The spectrometer (1) according to claim 55, wherein said interference layer is substituted by an array of resonant gratings.

58. The spectrometer (1) according to claim 57, wherein said resonant gratings are chirped resonant gratings.

59. The spectrometer (1) according to claim 40, wherein said optical filter element (40) comprises a plasmonic filter based on local resonances.
